(19) United States
(12) Patent Application Publication
(10) Pub. No.: US 2013/0107028 A1
(43) Pub. Date: May 2, 2013

(54) Microphone Device, Microphone System and Method for Controlling a Microphone Device

(71) Applicant: Sennheiser Electronic GmbH & Co. KG, Wedemark (DE)

(72) Inventors: Achim Gleißner, Diekholzen-Barienrode (DE); Kai Tossing, Hannover (DE); Jerome Zastrow, Burgwedel (DE)

(73) Assignee: Sennheiser Electronic GmbH & Co. KG, Wedemark (DE)

(21) Appl. No.: 13/661,368

(22) Filed: Oct. 26, 2012

(30) Foreign Application Priority Data
Oct. 28, 2011 (DE) 10 2011 085 361.8

(51) Int. Cl. H04R 3/00

(52) U.S. Cl. CPC H04R 3/00
USPC 348/77

(57) ABSTRACT

There is provided a microphone device comprising a camera having a field of vision for acquiring image data, a microphone unit with adjustable directivity and a control unit for adjusting the directivity of the microphone unit. Adjustment of the directivity of the microphone unit is based on ascertained position information of at least one user in the field of vision of the camera. The camera and/or the control unit are adapted to ascertain position information of at least one user from the image data acquired by the camera.

The present application claims priority from German Patent Application No. DE 10 2011 085 361.8 filed on Oct. 28, 2011, the disclosure of which is incorporated herein by reference in its entirety.

### 1. FIELD OF THE INVENTION

The present invention concerns a microphone device, a microphone system and a method of controlling a microphone device.

It is noted that citation or identification of any document in this application is not an admission that such document is available as prior art to the present invention.

Modern desktop computers or laptops typically have a webcam and a microphone to permit videochat or a video conference for example by way of Skype. The microphones used in that case however typically do not have any directivity so that it can happen that the signal-to-noise ratio is poor and the transmitted audio quality is low.

U.S. Pat. No. 6,731,334 discloses a system with a microphone array (a plurality of microphones), which determines the position of a speaker on the basis of the recorded audio signals and then directs a camera to the position of the speaker.

U.S. Pat. No. 6,009,210 discloses a face tracking system which is suitable for recognising a face in a camera field and appropriately following an optical virtual environment.

The German Patent and Trade Mark Office has searched the following state of the art in the priority application in respect of the present application: U.S. Pat. No. 5,490,118 A, U.S. Pat. No. 6,731,334 B1, U.S. Pat. No. 6,009,210 A, US No 2005/0111674 A1 and DE 198 54 373 A1.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right to disclaim, and hereby disclose a disclaimer of, any previously described product, method of making the product, or process of using the product.

### SUMMARY OF THE INVENTION

An object of the present invention is to provide a microphone device which has an improved signal-to-noise ratio and which can adapt the directivity of the microphone unit to the position of at least one person in the room.

Thus there is provided a microphone device comprising at least one camera having a field of vision for acquiring image data, at least one microphone unit with adjustable directivity and a control unit for adjusting the directivity of the microphone unit. Adjustment of the directivity of the at least one microphone unit is based on ascertained position information of at least one user in the field of vision of the camera. The camera and/or the control unit are adapted to ascertain position information of at least one user from the image data acquired by the camera. In addition the control unit is adapted to control focusing of the directivity of the microphone unit in accordance with the size of an acquired image portion based on face recognition.

In an aspect of the invention the position information of the at least one user is ascertained based on face recognition from the acquired image data of the camera. Face recognition is a simple way of detecting at least one user in a field of vision of the camera and then tracking a movement of the user.

In a further aspect of the invention the control unit is adapted to control the directivity of the microphone unit in such a way that there is more than one main direction of directivity if the camera detects more than one user in the field of vision.

In a further aspect of the invention the control unit is adapted to mute the output audio signal in dependence on the acquired audio and/or video signals.

The invention also concerns a method of controlling a microphone device which has a camera with a field of vision for acquiring image data and a microphone unit with an adjustable directivity. Position information of at least one user is ascertained from the image data acquired by the camera and the directivity of the microphone unit is adjusted based on that ascertained position information.

The invention also concerns a microphone system comprising at least a first and a second microphone device as described above. The first microphone device has a first detection region and the second microphone device has a second detection region.

The invention concerns the idea of providing a microphone device with a camera and a microphone unit (microphone array), wherein the microphone unit is designed to adapt the directivity of the microphone unit. Adaptation of the directivity of the microphone unit is based on position information of a speaker in a room, which was ascertained based on the output signals of the camera.

The step of ascertaining the position of a speaker can be effected for example in a control unit connected to the camera and the microphone array.

### BRIEF DESCRIPTION OF THE DRAWINGS

FIG. 1 shows a diagrammatic view of a microphone device according to a first embodiment;

FIGS. 2A-2C show various diagrammatic views of an orientation of the microphone device according to the first embodiment;

FIG. 3 shows a diagrammatic view of a microphone device according to a second embodiment; and

FIG. 4 shows a diagrammatic view of a microphone device according to a third embodiment.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

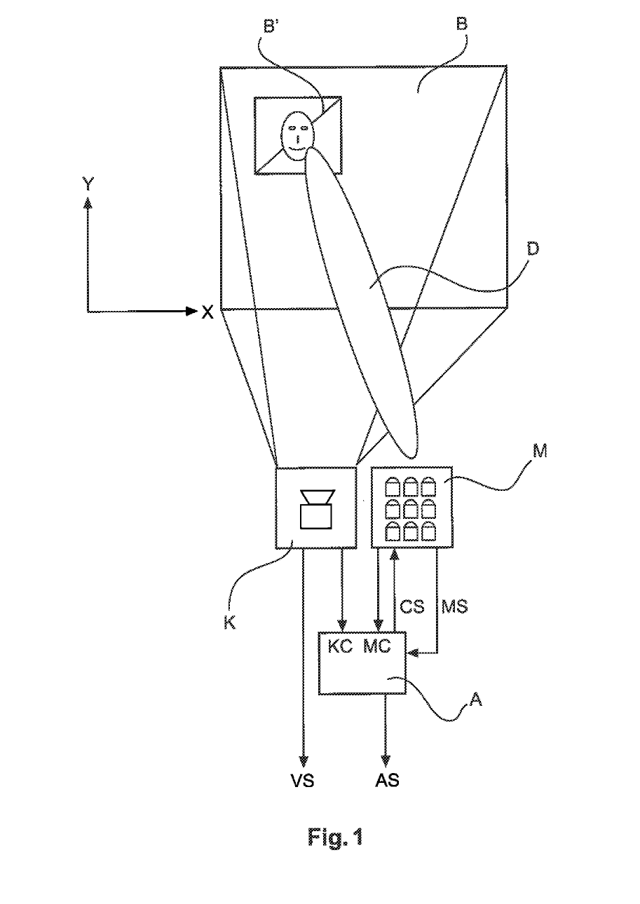

FIG. 1 shows a diagrammatic view of a microphone device according to a first embodiment. The microphone device of the first embodiment has at least one camera K for recording image data, at least one microphone unit (microphone array) M having a plurality of microphones for recording audio signals, and a control and/or evaluation unit A for evaluating the output signals of the camera K and for adjusting or adapting the directivity of the microphone unit M. The camera K can have a field of vision or an imaging size B, wherein the user is recognised within the field of vision B for example on the basis of features of the face. That facial feature recognition can be effected in the camera K or in the control unit A. The camera K (or the evaluation unit A), based on the facial features, ascertains an image portion B′ which is smaller than the imaging size or the field of vision B. In addition the position of the image portion B′ is detected (by the camera K or the control unit A) (that is to say the X- and Y-co-ordinates are detected). In addition an image diagonal Z of the image portion B′ can be ascertained. The parameter Z can also correspond to the distance of the user relative to the camera K.

The camera K can optionally output a camera control signal KC to the evaluation unit A. The camera control signal KC can include the parameters X, Y and Z. The evaluation unit A receives the camera control signal KC and, based on the position information contained there, a control signal CS is outputted to the microphone array M. As an alternative thereto the control unit can ascertain the parameters X, Y and Z from the camera signal.

The microphone unit (microphone array) M can output a microphone control signal MS to the evaluation unit A.

In addition the camera K can output a video signal VS and the microphone unit M can output a detected audio signal (optionally by way of the evaluation unit).

The evaluation unit A outputs an evaluation signal CS to the microphone unit M. The directivity of the microphone unit can be adjusted, based on that evaluation signal CS. The evaluation unit A will take account of the position information contained in the camera control signal KC in determining the evaluation signal CS in order to control or adapt the directivity of the microphone unit M in such a way that the directivity is adapted to the position of a user, as ascertained by the camera K. That is particularly advantageous because this can ensure that the signal-to-noise ratio of the detected audio signal can be optimised. In addition a spread angle of the microphone lobe of the microphone unit can optionally be adapted to the image diagonal of the image portion B′.

The video signal VS of the camera and the audio signal AS of the microphone unit M represent the output signals of the microphone unit.

Those signals can then be further processed in a subsequent signal processing operation. The subsequent signal processing operations can in that respect represent telecommunication devices or detection devices.

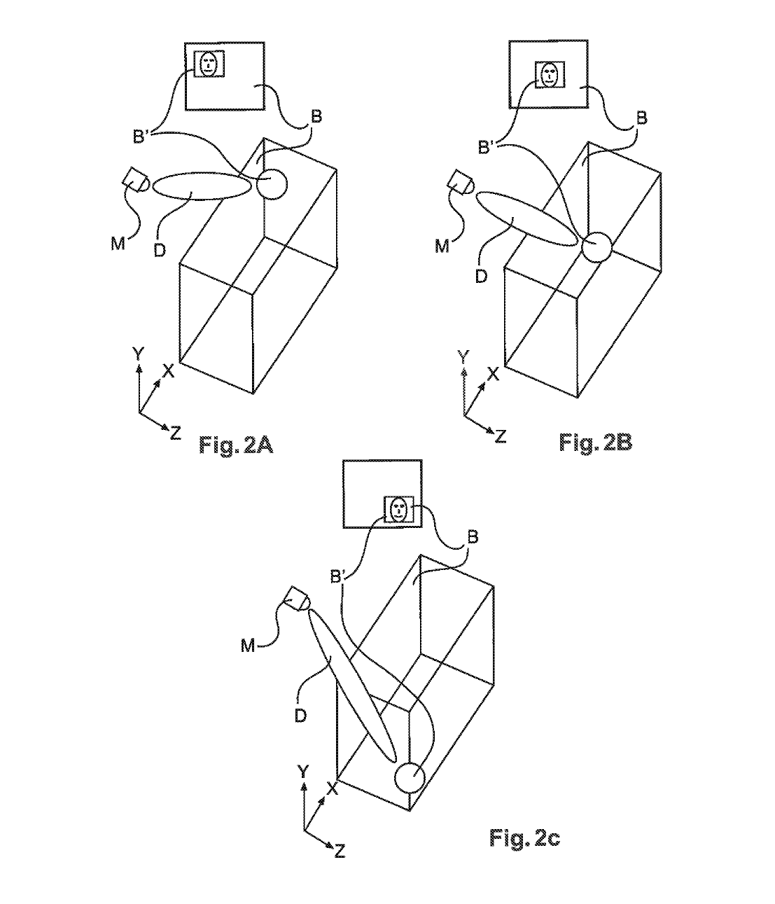

FIGS. 2A through 2C show various diagrammatic views of an orientation of the microphone device in accordance with the first embodiment. FIGS. 2A through 2C show various possible positions of a user of the microphone device. Firstly the respective imaging size (field of vision) B of the camera is shown, with a diagrammatic illustration of the microphone unit M and the directivity D of the microphone unit M. While in FIG. 2A the user is in the top left corner of the field of vision B of the camera K the user is substantially at the center in FIG. 2B. It can then also be seen from FIGS. 2A and 2B how the directivity of the microphone alters.

FIG. 2C shows a situation in which the user is in the bottom right corner and is further away in relation to the camera K. In this case also the directivity D of the microphone unit M changes.

The camera K according to the invention and/or the control unit and/or evaluation unit A can have a face tracking function. The transmitted image can represent for example a portion of the acquired image. The size and position of the transmitted image portion is calculated by recognition of facial features of a user. If the speaker moves relative to the camera then the image portion used changes and the camera tracks although the latter is stationary. That face tracking function can also control a zoom setting of the camera by face recognition.

Although in accordance with the first embodiment there is only one person in the imaging size B of the camera the invention can also be used when there are a number of people within the field of vision of the camera.

According to the invention the evaluation/control unit A can evaluate both the camera control signal KC and also the microphone signal MS. If the camera K does not detect a user within the area of detection of the camera then the output signal of the microphone unit can be muted, that is to say the audio signal is not reproduced. Muting of the audio channel can also be effected when both the camera does not detect a speaker and also the microphone unit M does not detect an audio signal.

In an aspect of the invention the audio signal detected by the microphone unit M can recognise a speaker only after a fixed time interval (for example 3 seconds). In that way it is possible to prevent an audio signal AS being outputted when the situation only involves a person being temporarily present and recognised in the field of vision of the camera K.

In a further aspect of the invention the audio channel can be muted not immediately but after a predetermined time interval if the camera K does not recognise a speaker in its field of vision.

The evaluation unit/control unit A can be adapted to control not only the directivity of the microphone unit M but also the amplification of the audio signal, in dependence on the position information for the user and the distance of the user relative to the camera.

In addition sound adaptation of the microphone signal in dependence on the distance of a speaker from the microphone unit M (which is detected by the camera K) can be ascertained. Thus for example it is possible to avoid a close talking effect.

In a further aspect of the invention the microphone signal can firstly be recorded and put into intermediate storage before it is outputted to the subsequent signal processing operation. That is effected if the camera detects a speaker or a person. If then an audio signal is thereafter also recorded or detected by the microphone unit M then firstly the audio signal is reproduced from the memory. In that respect the starting moment in time adopted is a moment in time shortly before the recognition time of the microphone. That delay between video signal and audio signal can be reduced in the course of further processing until the delay is minimised. Typically that delay can be caught up within between one and two seconds. In that way it is possible to avoid the beginnings of sentences being swallowed as is known from applications with pure audio control.

According to the invention the microphone device can have a camera and for example a two-dimensional microphone array (for example 9 MEMS microphone). The camera device can further have an evaluation unit/control unit A. The microphone device can be used for example in telepresence applications (for example home office while out and about). The microphone device according to the invention can also be used for example in IP telephony. The microphone device according to the invention can also be used when the video signal recorded by the camera is not also transmitted, that is to say the camera only serves to detect the position of the user so that the directivity of the microphone array can be appropriately adapted.

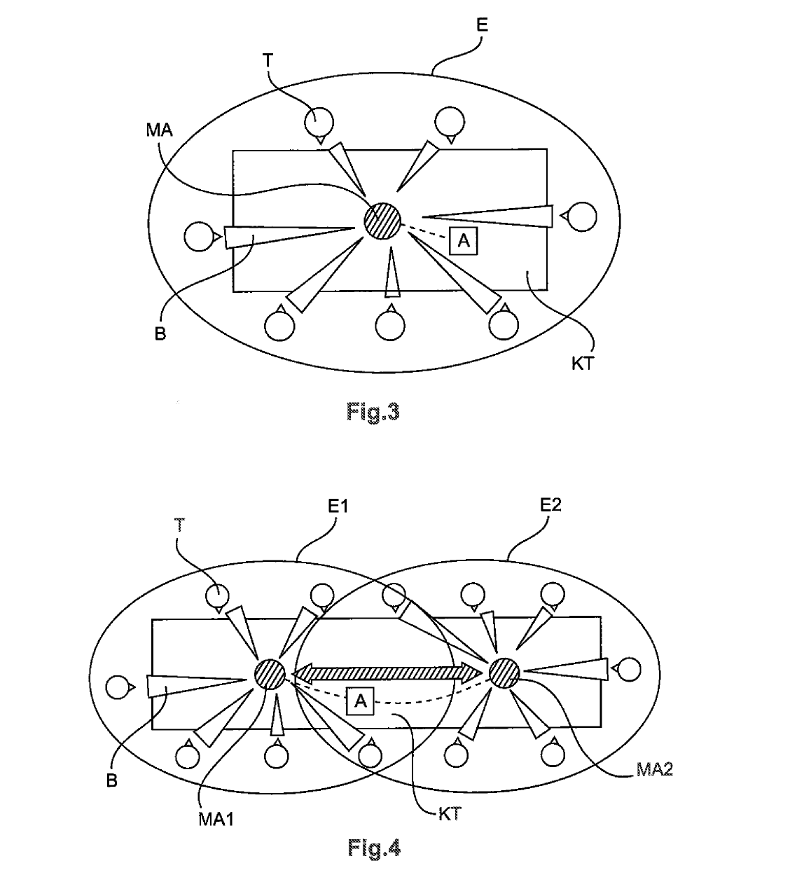

FIG. 3 shows a diagrammatic view of a microphone device according to a second embodiment. In the second embodiment a microphone device MA according to the invention can be placed on a conference table KT. A plurality of users or participants T can be present around the conference table. The microphone device of the second embodiment can be based on the microphone device of the first embodiment, that is to say it can have a camera K, a microphone unit M (for example a microphone array with a plurality of microphones) and a control unit A. In the second embodiment there can be a plurality of cameras K to be able to cover for example a 360° field of vision. As an alternative thereto one or more of the cameras can be adapted to be pivotable.

The microphone device of the second embodiment can have one or more microphone units. The position of at least one of the participants can be determined by means of the at least one camera K (as described in accordance with the first embodiment). That can be effected for example by face recognition and subsequent position calculation. A detection region E of the microphone device MA is preferably of such a configuration that it covers the region around the conference table KT.

FIG. 4 shows a diagrammatic view of a microphone device according to a third embodiment. In this case the microphone device of the third embodiment can be based on the microphone device of the second embodiment.

In accordance with the third embodiment two microphone devices MA1, MA2 are placed for example on a conference table KT and are adapted to detect at least one participant T by means of face recognition performed by the camera and subsequent determination of the position of the participant, and to orient the directivity of the at least one microphone unit in relation to the detected position information. The at least two microphone units MA1, MA2 can communicate with each other directly or indirectly, that is to say by way of the control unit A. The first microphone unit MA1 has a first detection region E1 and the second microphone device MA2 has a second detection region E2. If the user or participant T is present both in the first and also in the second detection region then the microphone devices MA1, MA2 and/or the control unit A can determine on the basis of the detected position information, which of the two microphone devices MA1, MA2 alters the directivity of the microphone units in such a way that the audio signals or speech signals of the user are detected. Alternatively it is also possible to use both microphone devices MA1, MA2 for detecting the audio or speech signals of the user. Then the control unit A can select the best audio signal from the two microphone devices MA1, MA2. Alternatively the two detected audio signals or speech signals can be superimposed to achieve better audio quality.

According to the invention the camera K and/or the control unit A can be adapted to produce and transmit meta-information about the user. That meta-information can represent for example the identity of the person. The identity of the person can be ascertained for example by face recognition and a comparison with known faces in a data bank. Alternatively optical codes like for example name tags, barcodes, a QR code or the like can be adopted to identify the persons detected by the camera.

According to the invention a detected audio signal or speech signal can be outputted (un-muted) if an authorised speaker is recognised. In that case for example the name of the speaker and further items of information relating to the speaker can be generated as metadata and stored in the signal. Optionally the detected audio signal can be processed in person-specific fashion, for example the sound settings can be implemented person-specifically.

In accordance with the second or third embodiment the camera can have a panoramic optical system or a rotating lens. Furthermore a plurality of cameras can be connected together to form a camera array in order to be able to cover as large a portion as possible around the microphone device. Such coverage can preferably involve 360°.

According to the second and third embodiment, if more than one participant T is detected, the number of microphone beams B are suitably produced, that is to say there are at least as many microphone beams as there are participants present. In that respect a microphone beam B represents a main directivity direction of at least one of the microphone units. Preferably those microphone beams B are directed on to one of the participants and in particular on to the speaker or speakers. Optionally the directivity or the audio beam B can be tracked, more specifically when the speaker moves. The microphone signals of the microphone unit can be mixed together in dependence on the number of microphone beams produced.

In accordance with a further embodiment based on the first, second or third embodiment the audio signals detected by the microphone (that is to say the audio signals detected by way of the microphone beams) are passed to a subsequent evaluation or control unit only when a useful signal (an audio signal or speech signal from a speaker) is also detected. In a further embodiment of the invention the items of angle information of the respective microphone beams can be embedded in the form of meta-information in the signal.

Optionally each participant T and speaker associated with one of the microphone beams B can be recognised by way of face recognition or the like and a corresponding identity can be associated with the face.

Based on those items of person-related information it is possible for example during a telephone conference to detect who is participating in the discussion and/or who is just then speaking.

In a further aspect of the invention, in the event of multi-channel spatial reproduction of the audio signal detected by the microphone devices MA, the items of angle information of the generated microphone beams can be used for a multi-channel situation.

In accordance with the third embodiment in FIG. 4 the microphone devices MA1, MA2 according to the invention can detect either independently or by means of the control unit A, whether there is another microphone device in the proximity. If it has been detected that there is another microphone device in the proximity, then a communication can be made between the microphone devices or by way of the control unit.

Recognition of an adjacent microphone device can be effected for example by way of an optical feature such as for example a label or an optical code. Positioning can be effected on the basis of the items of angle information and an autofocus signal.

According to an aspect of the present invention an environment for example of a teleconference installation with a given number of conference participants can be divided up amongst each other by the microphone devices MA1, MA2. In that case the central control unit A can serve to pass items of information about the recognised speakers to the connected microphone devices. If for example a user D is recognised by a plurality of microphone devices MA1, MA2 then the control unit A can decide which of the two signals is used. Alternatively both signals can be brought together to produce a corresponding audio signal of good quality.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A microphone device comprising;
at least one camera having at least one field of vision for acquiring image data;
at least one microphone unit having at least one adjustable directivity; and
a control unit configured to adjust the directivity of the at least one microphone unit based on ascertained position information of at least one user in the field of vision of the at least one camera;
wherein at least one of the camera and the control unit is adapted to ascertain position information of at least one user from the acquired image data; and
wherein the control unit is adapted to control focusing of the directivity of the microphone unit in accordance with the size of an acquired image portion based on face recognition.

2. The microphone device as set forth in claim 1;
wherein the position information of the user is ascertained based on face recognition from the acquired image data of the camera.

3. The microphone device as set forth in claim 1;
wherein the control unit is adapted to control the directivity of the microphone unit so that there is more than one main direction of directivity if more than one user has been detected on the basis of the ascertained position information.

4. The microphone device as set forth in claim 1;
wherein the control unit is adapted to mute the output audio signal in dependence on the acquired audio and/or video signals.

5. A microphone system comprising:
at least a first and a second microphone device, each of the first and second microphone devices comprising:
at least one camera having at least one field of vision for acquiring image data;
at least one microphone unit having at least one adjustable directivity; and
a control unit configured to adjust the directivity of the at least one microphone unit based on ascertained position information of at least one user in the field of vision of the at least one camera;
wherein at least one of the camera and the control unit is adapted to ascertain position information of at least one user from the acquired image data;
wherein the first microphone device has a first acquisition region and the second microphone device has a second acquisition region; and
wherein the first and second microphone devices are adapted to communicate with each other direct or indirectly.

6. The microphone system as set forth in claim 5, further comprisingg:
a control unit coupled to the first and second microphone units;
wherein, on the basis of the acquired position information, the control unit determines which of the two microphone devices changes the directivity of its microphone units so that the audio signals of the user are detected.

7. The microphone system as set forth in claim 5 or claim 6
wherein at least one of the first and second microphone devices is adapted to detect the audio signals of the user in the first and/or second detection region; and
wherein one of the first and second microphone devices which can best detect the audio signal of the user is selected for detection and transmission.

8. The microphone system as set forth in claim 5;
wherein the control unit is adapted to control focusing of the directivity of the microphone unit in accordance with the size of an acquired image portion based on face recognition.

9. A method of controlling at least one first microphone device, which has at least one camera with at least one field of vision for acquiring image data, and at least one microphone unit with an adjustable directivity, comprising the steps:
ascertaining position information from the acquired image data of the camera of at least one user in a field of vision of the camera; and
adjusting the directivity of the microphone unit based on the ascertained position information;
wherein focusing of the directivity of the microphone unit is controlled in accordance with the size of an acquired image portion based on face recognition.
